(19) United States
(12) Patent Application Publication
(10) Pub. No.: US 2005/0140587 A1
(43) Pub. Date: Jun. 30, 2005

(54) Method and apparatus for decreasing an afterimage of a plasma display panel

(76) Inventor: Dae Sik Cho, Gumi-si (KR)

Correspondence Address: MCKENNA LONG & ALDRIDGE LLP, 1900 K STREET, NW, WASHINGTON, DC, 20006, US

(21) Appl. No.: 10/968,178

(22) Filed: Oct. 20, 2004

(30) Foreign Application Priority Data
Oct. 21, 2003 (KR) 10-2003-0073312

(51) Int. Cl. G09G 3/28

(52) U.S. Cl. 345/63

(57) ABSTRACT

The present invention relates to a plasma display panel, and more particularly to a method and apparatus for decreasing an afterimage of a plasma display panel. According to an embodiment of the present invention, a method for decreasing an afterimage of a plasma display panel by using an average picture level, comprises the steps of: generating an average picture level-to-sustain pulse number curve having a trigonometric function period or a linear function period; and driving the plasma display panel by calculating an average picture level of an input image, and deriving the number of sustain pulses corresponding to the calculated average picture level from the average picture level-to-the number of sustain pulses curve. The method and appratus for decreasing an afterimage of a PDP by using an APL according to the present invention can minimize the afterimage by using an APL-Nsus curve having a trigonometric function period or a linear function period and preventing an abrupt change in the number of sustain pulses when the APL varies.

This Nonprovisional application claims priority under 35 U.S.C. § 119(a) on Patent Application No. 10-2003-0073312 filed in Korea on Sep. 21, 2003, the entire contents of which are hereby incorporated by reference.

### BACKGROUND OF THE INVENTION

1. Field of the Invention

The present invention relates to a plasma display panel, and more particularly to a method and apparatus for decreasing an afterimage of a plasma display panel.

2. Description of the Background Art

A plasma display panel (hereinafter, referred to as “PDP”) displays an image by using a visible ray generated from a phosphor material when ultraviolet rays produced by a gas discharge excite the phosphor material. Such a PDP has many advantages over a cathode ray tube (CRT) which has been widely used so far in that it is thinner in thickness, higher in definition, and larger in a screen size.

FIG. 1 is a plan view schematically illustrating a conventional plasma display panel.

Referring to FIG. 1, a tri-electrode AC (Alternative Current) surface discharge type PDP includes scan electrodes Y1 to Yn and sustain electrodes Z formed on an upper substrate 10, and address electrodes X1 to Xm formed on a lower substrate 18. Discharge cells 1 of the PDP are formed at a part where the scan electrodes Y1 to Yn, the sustain electrodes Z and the address electrodes X1 to Xm are crossed with one another.

In the above-described PDP, a gray scale of an image is achieved on a time-division basis by dividing one frame into many subframes each having the different number of light emissions. Each subfield is further divided into a reset period for uniformly creating a discharge, an address period for selecting a discharge cell, and a sustain period for achieving a gray scale according to the number of light emissions. For example, if it is desired to display an image by 256 gray scales, a frame period (36.67 ms) corresponding to 1/60 seconds is divided into 8 subfields. Each of the 8 subfields is further divided into a reset period, an address period and a sustain period. In this case, the reset period and the address period of each subfield are identical to each other, whereas the sustain period and the number of light emissions are proportional to the number of sustain pulses and increase at a rate of 2ⁿ (where n=0, 1, 2, 3, 4, 5, 6, and 7). Thus since the sustain period of each subfield becomes different, it is possible to obtain a desired gray scale of an image.

FIG. 2 is a block diagram illustrating a driving circuit of a conventional PDP.

Referring to FIG. 2, the PDP driving circuit includes a gain correcting part 22, an error spreading part 23 and a subfield mapping part 24 connected between a first reverse gamma correcting part 21A and a data arranging part 25, and includes a average picture level (APL) calculating part 26 connected between a second reverse gamma correcting part 21B and a waveform generating part 27.

The first and second reverse gamma correcting parts 21A and 21B perform reverse gamma correction on red, green and blue (RGB) digital video data from an input line 20 to convert luminance corresponding to a gray scale of a video signal into a linear value.

The gain correcting part 22 compensates a color temperature by adjusting an effective gain according to respective data of RGB colors.

The error spreading part 23 minutely adjusts a luminance value by spreading to adjacent cells a quantization error of the RGB input digital video data received from the gain correcting part 22.

The subfield mapping part 24 maps data received from the error spreading part 23 to a subfield pattern stored previously according to each bit and supplies the mapped data to the data arranging part 25.

The data arranging part 25 supplies a data driving circuit of a PDP 28 with digital video data received from the subfield mapping part 24. The data driving circuit connected to data electrodes of the PDP 28 latches data received from the data arranging part 25 on a horizontal line basis and supplies the latched data to the data electrodes of the PDP 28 in the unit of one horizontal period.

The APL calculating part 26 calculates an APL of RGB digital video data received from the second reverse gamma correcting part 21B in the unit of one screen, and generates information about the number of sustain pulses corresponding to the calculated APL. The information about the number of sustain pulses corresponding to the APL calculated in the APL calculating part 26 is stored in a lookup table of a ROM (Read Only Memory) contained in the APL calculating part 26. An APL-Nsus (the number of sustain pulses) curve shows an exponential function shape in which the number of sustain pulses decreases nonlinearly as the APL increases.

The waveform generating part 27 generates a timing control signal in response to the information about the number of sustain pulses from the APL calculating part 26 and supplies the timing control signal to a scan driving circuit and a sustain driving circuit which are not shown. The scan driving circuit and the sustain driving circuit supply sustain pulses to the scan electrodes and sustain electrodes of the PDP 28 during a sustain period in response to the timing control signal received from the waveform generating part 27.

Although the PDP can reduce consumed power by controlling the APL, since the APL-Nsus curve is nonlinear, an afterimage becomes severer. For instance, as shown in FIG. 4, the PDP driving circuit partially displays a bright part on the PDP and then displays the bright image on the whole screen with the same brightness. However, even though the bright image is displayed on the whole screen with the same brightness, the bright part which has been discharged becomes brighter and an afterimage remains. This is because the number of sustain pulses decreases abruptly when the partially bright image (that is, an image with a low APL) changes to the entirely bright image (that is, an image with a high APL). Therefore, priming charge particles exist within a cell at a previously discharged part, and due to the priming charge particles, the previously discharged part appears to be brighter than a part which has been not discharged. In other words, the afterimage phenomenon is caused by an abrupt increase or decrease ΔNsus in the number of sustain pulses according to the ALP by the APL-Nsus curve of an exponential function shape.

### SUMMARY OF THE INVENTION

Accordingly, an object of the present invention is to solve at least the problems and disadvantages of the background art.

An object of the present invention is to provide a method and an apparatus for decreasing an afterimage of a PDP by using a prescribed function period on an APL-Nsus curve.

According to an embodiment of the present invention, a method for decreasing an afterimage of a plasma display panel by using an average picture level, comprises the steps of: generating an average picture level-to-sustain pulse number curve having a trigonometric function period or a linear function period; and driving the plasma display panel by calculating an average picture level of an input image, and deriving the number of sustain pulses corresponding to the calculated average picture level from the average picture level-to-the number of sustain pulses curve.

According to an embodiment of the present invention, an apparatus for decreasing an afterimage of a plasma display panel by using an average picture level, comprises: an average picture level calculating part for calculating an average picture level of an input image, and deriving the number of sustain pulses corresponding to the calculated average picture level from an average picture level-to-sustain pulse number curve having a trigonometric function period or a linear function period; and a driving part for a driving the plasma display panel by using the number of sustain pulses derived by the average picture level calculating part.

The method and appratus for decreasing an afterimage of a PDP by using an APL according to the present invention can minimize the afterimage by using an APL-Nsus curve having a trigonometric function period or a linear function period and preventing an abrupt change in the number of sustain pulses when the APL varies.

### BRIEF DESCRIPTION OF THE DRAWINGS

The invention will be described in detail with reference to the following drawings in which like numerals refer to like elements.

FIG. 1 is a plan view schematically illustrating a conventional plasma display panel (PDP).

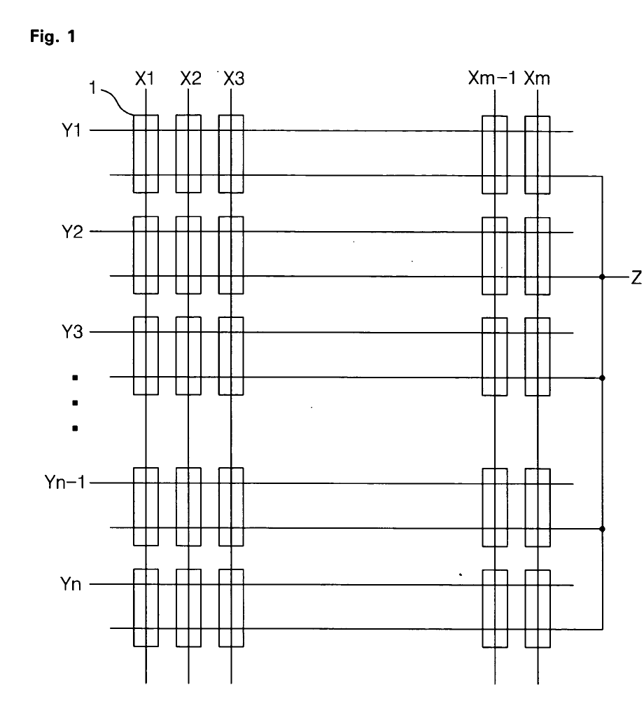

FIG. 2 is a block diagram illustrating a driving circuit of a conventional PDP.

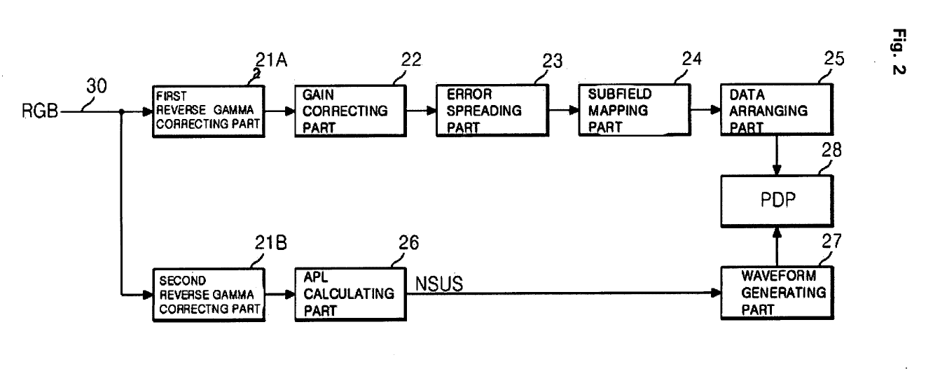

FIG. 3 is a graph illustrating a conventional APL (average picture level)-Nsus (the number of sustain pulses) curve.

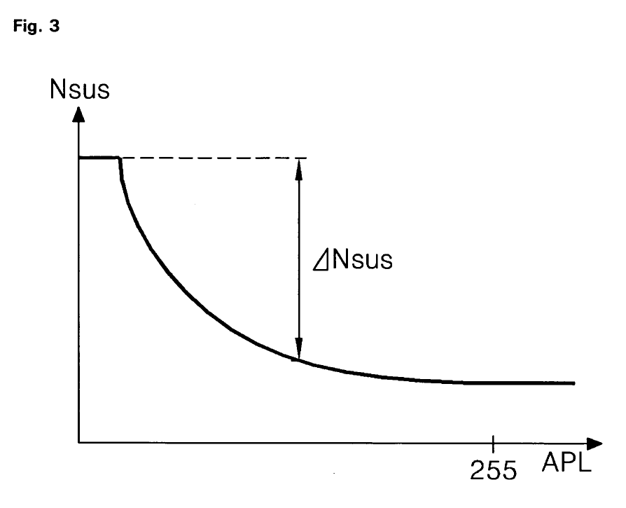

FIG. 4 is a diagram illustrating an example of generating an afterimage when a PDP is driven using the APL-Nsus curve shown in FIG. 3.

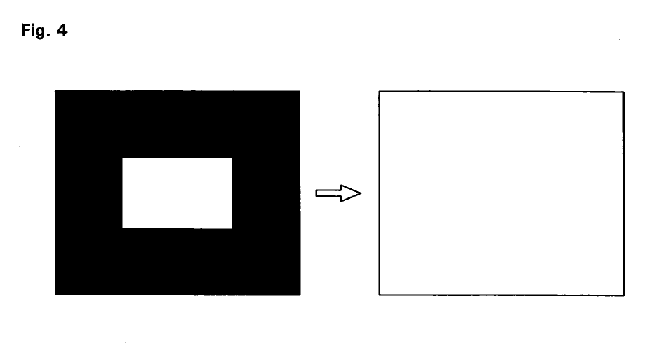

FIG. 5 is a block diagram illustrated to describe a method and apparatus for decreasing an afterimage of a PDP according to the present invention.

FIG. 6 is a graph illustrating an APL-Nsus curve according to a first embodiment of the present invention.

FIG. 7 is a graph illustrating an APL-Nsus curve according to a second embodiment of the present invention.

FIG. 8 is a graph illustrating an APL-Nsus curve according to a third embodiment of the present invention.

### DETAILED DESCRIPTION OF PREFERRED EMBODIMENTS

Preferred embodiments of the present invention will be described in a more detailed manner with reference to the drawings.

According to an embodiment of the present invention, a method for decreasing an afterimage of a plasma display panel by using an average picture level, comprises the steps of: generating an average picture level-to-sustain pulse number curve having a trigonometric function period or a linear function period; and driving the plasma display panel by calculating an average picture level of an input image, and deriving the number of sustain pulses corresponding to the calculated average picture level from the average picture level-to-the number of sustain pulses curve.

Further, the trigonometric function period or the linear function period exists between 5 and 95 percent of a peak average picture level on the average picture level-to-the sustain pulse number curve.

According to an embodiment of the present invention, an apparatus for decreasing an afterimage of a plasma display panel by using an average picture level, comprises: an average picture level calculating part for calculating an average picture level of an input image, and deriving the number of sustain pulses corresponding to the calculated average picture level from an average picture level-to-sustain pulse number curve having a trigonometric function period or a linear function period; and a driving part for a driving the plasma display panel by using the number of sustain pulses derived by the average picture level calculating part.

Further, the trigonometric function period or the linear function period exists between 5 and 95 percent of a peak average picture level on the average picture level-to-sustain pulse number curve.

Hereinafter, Preferred embodiments of the present invention will be described in a more detail with the drawings.

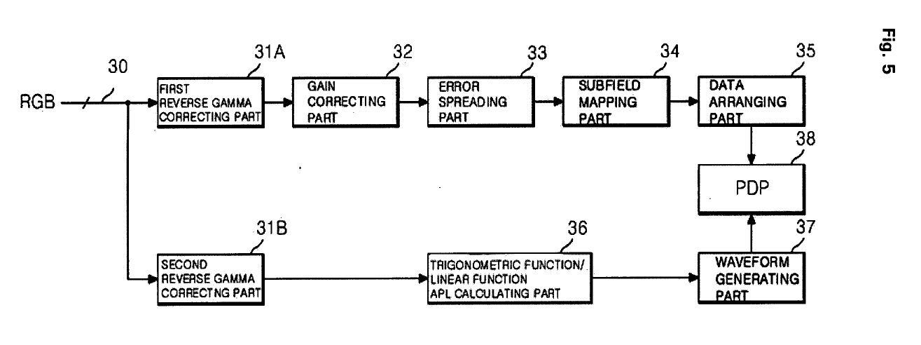

FIG. 5 is a block diagram illustrated to describe a method and apparatus for decreasing an afterimage of a PDP according to the present invention. Referring to FIG. 5, a PDP driving circuit according to the present invention includes a gain correcting part 32, an error spreading part 33 and a subfield mapping part 34 connected between a first reverse gamma correcting part 31A and a data arranging part 35, and includes a trigonometric function/linear function APL calculating part 36 connected between a second reverse gamma correcting part 31B and a waveform generating part 37.

The first and second reverse gamma correcting parts 31A and 31B perform reverse gamma correction on RGB digital video data from an input line 30 to convert luminance corresponding to a gray scale of a video signal into a linear value.

The gain correcting part 32 compensates a color temperature by adjusting an effective gain according to respective data of RGB colors.

The error spreading part 33 minutely adjusts a luminance value by spreading to adjacent cells a quantization error of the RGB input digital video data received from the gain correcting part 32.

The subfield mapping part 34 maps data received from the error spreading part 33 to a subfield pattern stored previously according to each bit and supplies the mapped data to the data arranging part 35.

The data arranging part 35 supplies a data driving circuit of a PDP 38 with digital video data received from the subfield mapping part 34. The data driving circuit connected to data electrodes of the PDP 38 latches data received from the data arranging part 35 on a horizontal line basis and supplies the latched data to the data electrodes of the PDP 38 in the unit of one horizontal period.

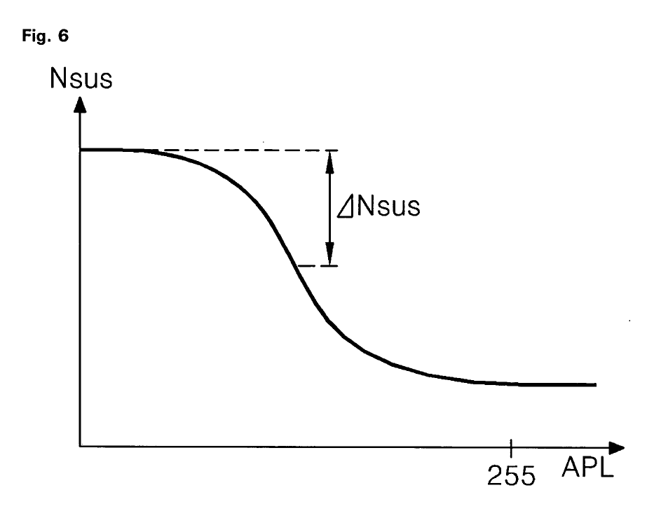

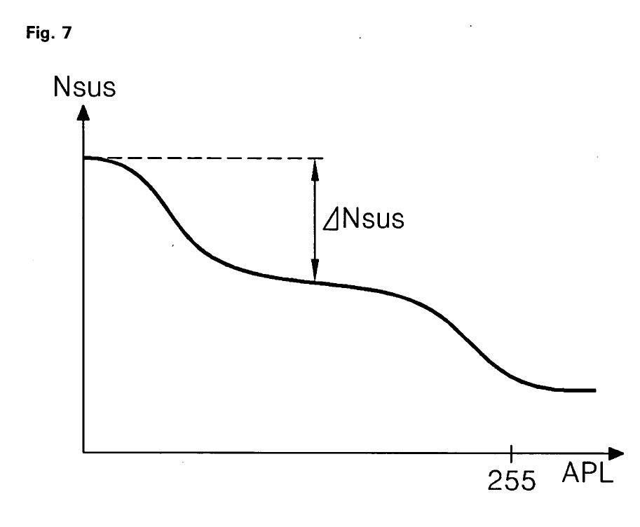

The trigonometric function/linear function APL calculating part 36 calculates an APL of data received from the second reverse gamma correcting part 31B, and derives the number of sustain pulses, Nsus, corresponding to the calculated APL from an APL-Nsus curve having a trigonometric function period. The NPL-Nsus curve having the trigonometric function period includes a sine (Sin) or cosine (Cos) function as shown in FIG. 6 or 7. Further, the trigonometric function/linear function APL calculating part 36 calculates an APL of data received from the second reverse gamma correcting part 31B, and derives the Nsus corresponding to the calculated APL from an APL-Nsus curve having a linear function period.

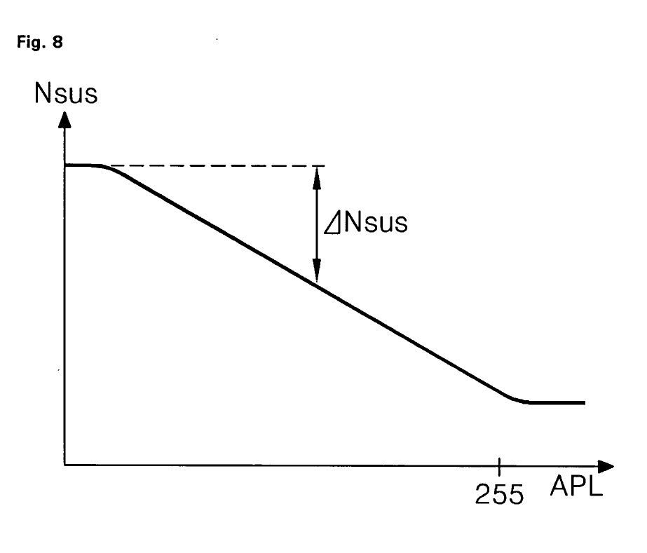

An example of the NPL-Nsus curve having the linear function period is shown in FIG. 8. The trigonometric function period or the linear function period exists between 5 and 95 percent of a peak APL, that is, a maximum average brightness on the APL-Nsus curve. The APL-Nsus curve is stored in a ROM (not shown) as lookup table data.

The waveform generating part 37 generates a timing control signal in response to information about the Nsus from the trigonometric function/linear function APL calculating part 36 and supplies the timing control signal to a scan driving circuit and a sustain driving circuit which are not shown. The scan driving circuit and the sustain driving circuit supply sustain pulses to the scan electrodes and sustain electrodes of the PDP 38 during a sustain period in response to the timing control signal received from the waveform generating part 37.

As described above, the method and apparatus for decreasing an afterimage of a PDL according to the present invention drives the PDP by using the APL-Nsus curve having the trigonometric function period or the linear function period. Therefore, the method and apparatus can prevent the number of sustain pulses from being abruptly changed when the APL varies. As a result, even though a bright part is partially displayed on the PDP and then it is displayed on the whole screen with the same brightness, an afterimage remains hardly because the number of sustain pulses does not change abruptly.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method for decreasing an afterimage of a plasma display panel by using an average picture level, comprising the steps of:
generating an average picture level-to-sustain pulse number curve having a trigonometric function period or a linear function period; and
driving the plasma display panel by calculating an average picture level of an input image, and deriving the number of sustain pulses corresponding to the calculated average picture level from the average picture level-to-the number of sustain pulses curve.

2. The method as claimed in claim 1, wherein the trigonometric function period or the linear function period exists between 5 and 95 percent of a peak average picture level on the average picture level-to-the sustain pulse number curve.

3. An apparatus for decreasing an afterimage of a plasma display panel by using an average picture level, comprising:
an average picture level calculating part for calculating an average picture level of an input image, and deriving the number of sustain pulses corresponding to the calculated average picture level from an average picture level-to-sustain pulse number curve having a trigonometric function period or a linear function period; and
a driving part for a driving the plasma display panel by using the number of sustain pulses derived by the average picture level calculating part.

4. The apparatus as claimed in claim 3, wherein the trigonometric function period or the linear function period exists between 5 and 95 percent of a peak average picture level on the average picture level-to-sustain pulse number curve.
